(19) United States
(12) Patent Application Publication
(10) Pub. No.: US 2026/0133534 A1
(43) Pub. Date: May 14, 2026

(54) CONVEYANCE APPARATUS

(71) Applicant: Konica Minolta, Inc., Tokyo (JP)

(72) Inventor: Shimpei KANAMORI, Tokyo (JP)

(21) Appl. No.: 19/353,846

(22) Filed: Oct. 9, 2025

(30) Foreign Application Priority Data
Nov. 11, 2024 (JP) 2024-196579

(51) Int. Cl. G03G 15/00

(52) U.S. Cl. CPC G03G 15/6573; G03G 15/657; G03G 15/6579; G03G 2215/00413; G03G 2215/0043

(57) ABSTRACT

Provided is a conveyance apparatus that includes: a conveyance route that conveys a recording medium on which an image has been fixed by a fixer; a guide plate that is provided in the conveyance route and guides conveyance of the recording medium; a heat insulating material that is attached to the guide plate; and a resin sheet having electrical conductivity that is provided such that the heat insulating material is held between the resin sheet and the guide plate. The resin sheet is grounded.

### CROSS REFERENCE TO RELATED APPLICATIONS

The entire disclosure of Japanese patent Application No. 2024 -196579, filed on November 11, 2024, is incorporated herein by reference in its entirety.

### BACKGROUND

### 1 . Technological Field

The present invention relates to a conveyance apparatus.

### 2. Description of the Related Art

In the related art, in an image forming apparatus including a fixer, dew condensation may occur in a guide of a conveyance route due to a recording medium immediately after fixation being in a high-temperature state. For example, Japanese Patent Publication Laid-Open No. 2007-91382 discloses a configuration in which a heat insulating sheet is attached to an upper structure of a conveyance route, and a PET film is supported by the heat insulating sheet in a cantilever manner. With this structure, the frictional resistance of the recording medium is reduced by the PET film while the occurrence of dew condensation is suppressed by the heat insulating sheet.

### SUMMARY

However, in the configuration described in Japanese Patent Publication Laid-Open No. 2007-91382, there is a possibility that the recording medium will be electrostatically adsorbed to the PET film. For this reason, there is a possibility that conveyance resistance of the recording medium will increase due to the electrostatic adsorption, and consequently, there is a risk that defects such as jam and wrinkling of the recording medium may occur.

An object of the present invention is to provide a conveyance apparatus capable of suppressing the occurrence of defects due to the electrostatic adsorption of a recording medium while suppressing the occurrence of dew condensation in a conveyance route.

In order to achieve at least one of the above-described objects, a conveyance apparatus reflecting one aspect of the present invention includes: a conveyance route that conveys a recording medium on which an image has been fixed by a fixer; a guide plate that is provided in the conveyance route and guides conveyance of the recording medium; a heat insulating material that is attached to the guide plate; and a resin sheet having electrical conductivity that is provided such that the heat insulating material is held between the resin sheet and the guide plate. The resin sheet is grounded.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus according to an embodiment of the present invention;

FIG. 2 is a diagram illustrating a main part of a control system of the image forming apparatus;

FIG. 3 is a diagram illustrating a guide as viewed from below;

FIG. 4 is a side view of the guide;

FIG. 5 is a diagram illustrating the guide according to a variation as viewed from below; and

FIG. 6 is a diagram of the guide according to a variation as viewed from below.

### DETAILED DESCRIPTION OF EMBODIMENTS

Hereinafter, one or more embodiments of the present invention will be described with reference to the drawings. However, the scope of the invention is not limited to the disclosed embodiments.

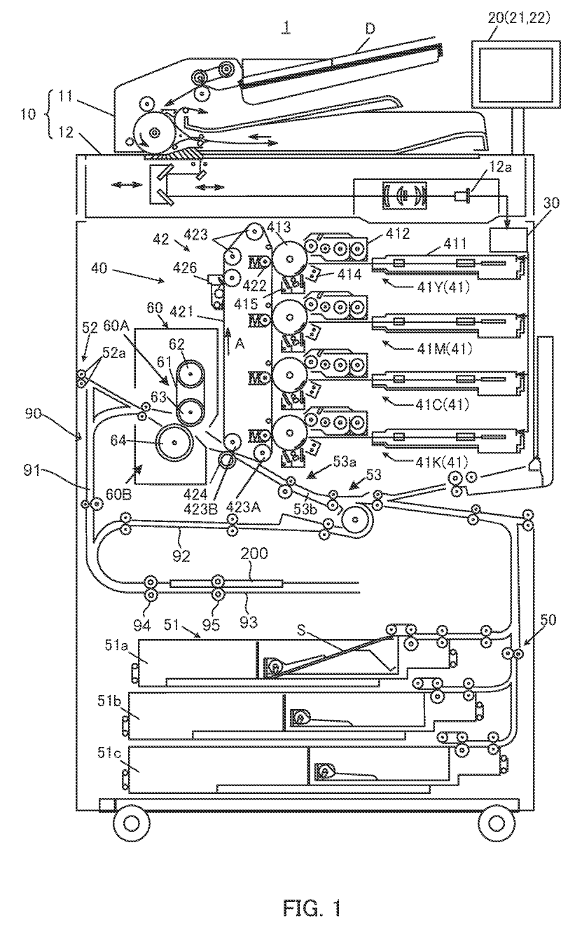

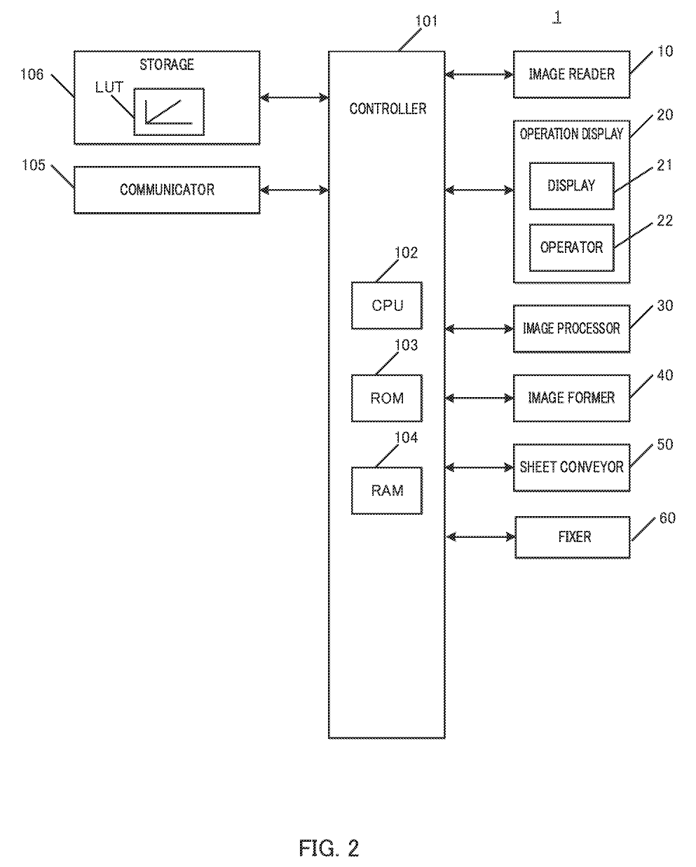

Hereinafter, an embodiment of the present invention will be described in detail with reference to the accompanying drawings. FIG. 1 is a diagram schematically illustrating an overall configuration of an image forming apparatus 1 according to an embodiment of the present invention. FIG. 2 is a diagram illustrating a main part of a control system of the image forming apparatus 1.

As illustrated in FIG. 1, the image forming apparatus 1 is a color image forming apparatus of an intermediate transfer method utilizing an electrophotographic process technology. That is, the image forming apparatus 1 primary-transfers toner images of colors of yellow (Y), magenta (M), cyan (C), and black (K) formed on photosensitive drums 413 onto an intermediate transfer belt 421, superimposes the toner images of the four colors on one another on the intermediate transfer belt 421, and then secondary-transfers the resultant image onto a sheet S (recording medium) fed out from sheet feed tray units 51a to 51c to form an image.

In addition, the image forming apparatus 1 adopts a tandem-system in which the photosensitive drums 413 corresponding to the four colors of Y, M, C, and K are arranged in series in the travel direction of the intermediate transfer belt 421, and the toner images of the respective colors are sequentially transferred onto the intermediate transfer belt 421 by a single procedure.

As illustrated in FIG. 2, the image forming apparatus 1 includes an image reader 10, an operation display 20, an image processor 30, an image former 40, a sheet conveyor 50, a fixer 60, and a controller 101. The image forming apparatus 1 corresponds to the “conveyance apparatus” according to the present invention.

The controller 101 includes a central processing unit (CPU) 102, a read only memory (ROM) 103, a random access memory (RAM) 104, and the like. The CPU 102 reads a program corresponding to the processing content from the ROM 103, develops the program in the RAM 104, and performs centralized control of the operation of each block and the like of the image forming apparatus 1 in conjunction with the developed program. At this time, various types of data stored in a storage 106 are referred to. The storage 106 is constituted by, for example, a non-volatile semiconductor memory (so-called flash memory) and/or a hard disk drive.

The controller 101 transmits/receives various types of data to/from an external apparatus (for example, a computer) connected to a network such as a local area network (LAN) or a wide area network (WAN) via a communicator 105. For example, the controller 101 receives image data (input image data) transmitted from the external apparatus and causes an image to be formed on the sheet S based on the image data. The communicator 105 is constituted by a communication control card such as a LAN card.

As illustrated in FIG. 1, the image reader 10 is configured to include an automatic document feeding apparatus 11 called an auto document feeder (ADF), a document image scanning apparatus 12 (scanner), and the like.

The automatic document feeding apparatus 11 conveys a document D, which has been placed on a document tray, by a conveyance mechanism and feeds out the document D to the document image scanning apparatus 12. The automatic document feeding apparatus 11 makes it possible to continuously and collectively read images of a large number of documents D (including both surfaces) placed on the document tray.

The document image scanning apparatus 12 optically scans a document conveyed from the automatic document feeding apparatus 11 onto a contact glass or a document placed on the contact glass, forms an image of reflected light from the document on a light receiving surface of a charge-coupled device (CCD) sensor 12a, and reads a document image. The image reader 10 generates input image data based on a reading result by the document image scanning apparatus 12. The input image data undergoes predetermined image processing at the image processor 30.

As illustrated in FIG. 2, the operation display 20 is constituted by, for example, a liquid crystal display (LCD) with a touch screen, and functions as a display 21 and an operator 22. The display 21 displays various operation screens, the state of the image, the operation status of each function, and the like according to a display control signal inputted from the controller 101. The operator 22 includes various operation keys such as a numeric keypad, and a start key, receives various input operations from a user, and outputs an operation signal to the controller 101.

The image processor 30 includes a circuit or the like that performs digital image processing corresponding to initial settings or user settings. For example, the image processor 30 performs gradation correction based on gradation correction data (gradation correction table) under the control of the controller 101. The image processor 30 performs, in addition to the gradation correction, various types of correction processing such as color correction and shading correction, compression processing, and the like. The image former 40 is controlled based on the image data on which the above-described pieces of processing have been performed. Details of the image processor 30 will be described later.

As illustrated in FIG. 1, the image former 40 forms an image on the sheet S based on the settings of a print job. The image former 40 includes image forming units 41Y, 41M, 41C, and 41K for forming images with color toners of Y, M, C, and K components based on the input image data, an intermediate transfer unit 42, and the like.

The image forming units 41Y, 41M, 41C, and 41K for the Y, M, C, and K components have a similar configuration. For convenience of illustration and description, common constituent elements are denoted by the same reference signs, and in a case where the common constituent elements are distinguished from each other, Y, M, C, or K is added to the reference signs. In FIG. 1, reference signs are assigned to only the constituent elements of the image forming unit 41Y for the Y component and the reference signs of the constituent elements of the other image forming units 41M, 41C, 41K are omitted.

The image forming unit 41 includes an exposure apparatus 411, a developing apparatus 412, a photosensitive drum 413, a charging apparatus 414, a drum cleaning apparatus 415, and the like.

The photosensitive drum 413 is made of, for example, an organic photoreceptor in which a photosensitive layer made of a resin containing an organic photoconductor is formed on the outer periphery surface of a drum-shaped metal base.

The controller 101 controls a drive current supplied to a drive motor (not illustrated) that rotates the photosensitive drum 413 to rotate the photosensitive drum 413 at a constant peripheral speed.

The charging apparatus 414 is, for example, a charging charger, and uniformly charges the surface of the photosensitive drum 413 having photoconductivity to a negative polarity by generating corona discharge.

The exposure apparatus 411 is constituted by, for example, a semiconductor laser, and emits laser light corresponding to an image of each color component to the photosensitive drum 413. As a result, in the surface of the photosensitive drum 413, due to a potential difference from the background region, an electrostatic latent image of each color component is formed on the image region to which the laser light is emitted.

The developing apparatus 412 is a developing apparatus of a two-component reverse rotation type, and forms a toner image by causing a developer of each color component to adhere to the surface of the photosensitive drum 413 to visualize an electrostatic latent image.

For example, DC developing bias having the same polarity as a charge polarity of the charging apparatus 414 or developing bias, in which DC voltage having the same polarity as the charge polarity of the charging apparatus 414 is superimposed on AC voltage, is applied to the developing apparatus 412. As a result, inversion development is performed in which a toner is caused to adhere to an electrostatic latent image formed by the exposure apparatus 411.

The drum cleaning apparatus 415 is caused to abut on the surface of the photosensitive drum 413, includes a plate-shaped cleaning blade made of an elastic body or the like, and removes a toner not transferred onto the intermediate transfer belt 421 and remaining on the surface of the photosensitive drum 413.

The intermediate transfer unit 42 includes the intermediate transfer belt 421, primary transfer rollers 422, a plurality of support rollers 423, a secondary transfer roller 424, a belt cleaning apparatus 426, and the like.

The intermediate transfer belt 421 is constituted by an endless-shaped belt and is stretched in a loop shape over the plurality of support rollers 423. At least one of the plurality of support rollers 423 is constituted by a drive roller, and the other support roller(s) 423 is/are constituted by a driven roller(s). For example, a roller 423A disposed on the downstream side of the primary transfer roller 422 for the K component in the belt travel direction is preferably a drive roller. Thus, the travel speed of the belt at a primary transfer section is easily kept constant. The rotation of the drive roller 423A causes the intermediate transfer belt 421 to travel in the direction of an arrow A at a constant speed.

The intermediate transfer belt 421 is a belt having conductivity and elasticity, and includes a high-resistance layer on the surface thereof. The intermediate transfer belt 421 is rotationally driven by a control signal from the controller 101.

The primary transfer roller 422 is disposed on the side of the inner periphery surface of the intermediate transfer belt 421 with the primary transfer roller 422 facing the photosensitive drum 413 of each color component. The primary transfer roller 422 is brought into pressure contact with the photosensitive drum 413 with the intermediate transfer belt 421 held therebetween, thereby forming a primary transfer nip for transferring a toner image from the photosensitive drum 413 onto the intermediate transfer belt 421.

The secondary transfer roller 424 is disposed on the side of the outer peripheral surface of the intermediate transfer belt 421 with the secondary transfer roller 424 facing a backup roller 423B disposed on the downstream side of the drive roller 423A in the belt travel direction. The secondary transfer roller 424 is brought into pressure contact with the backup roller 423B with the intermediate transfer belt 421 held therebetween, thereby forming a secondary transfer nip for transferring a toner image from the intermediate transfer belt 421 onto the sheet S.

When the intermediate transfer belt 421 passes through the primary transfer nips, the toner images on the photosensitive drums 413 are sequentially superimposed and primary-transferred onto the intermediate transfer belt 421. Specifically, the toner image is electrostatically transferred onto the intermediate transfer belt 421 by applying primary transfer bias to the primary transfer roller 422, and applying electric charge having an opposite polarity of the toner to the side of the back surface of the intermediate transfer belt 421, that is, the side on which the primary transfer roller 422 abuts.

Thereafter, when the sheet S passes through the secondary transfer nip, the toner image on the intermediate transfer belt 421 is secondary-transferred onto the sheet S. Specifically, the toner image is electrostatically transferred onto the sheet S by applying secondary transfer bias to the secondary transfer roller 424, and applying electric charge having an opposite polarity of the toner to the side of the back surface of the sheet S, that is, the side on which the secondary transfer roller 424 abuts. The sheet S onto which the toner image has been transferred is conveyed toward the fixer 60.

The belt cleaning apparatus 426 removes a transfer residual toner remaining on the surface of the intermediate transfer belt 421 after the secondary transfer.

The fixer 60 includes an upper-side fixer 60A, a lower-side fixer 60B, a heating source, and the like. The upper-side fixer 60A includes a fixing surface-side member that is disposed on the side of a fixing surface of the sheet S, that is, the surface on which the toner image has been formed. The lower-side fixer 60B includes a back surface-side supporting member that is disposed on the side of the back surface of the sheet S, that is, the side of the surface opposite to the fixing surface. The back surface-side supporting member is brought into pressure contact with the fixing-surface-side member, so that a fixing nip is formed which holds the sheet S in between and conveys the sheet S.

The fixer 60 heats and pressurizes the conveyed sheet S, onto which the toner image has been secondary-transferred, at the fixing nip, thereby fixing the toner image on the sheet S. The fixer 60 is disposed as a unit in a fixing device.

The upper-side fixer 60A includes a fixing belt 61 having an endless shape, which is the fixing-surface-side member, a heating roller 62, and a fixing roller 63. The fixing belt 61 is stretched by the heating roller 62 and the fixing roller 63.

The lower-side fixer 60B includes a pressure roller 64 that is the back surface-side supporting member. The pressure roller 64 and the fixing belt 61 form a fixing nip that holds the sheet S in between and conveys the sheet S.

The sheet conveyor 50 includes a sheet feeder 51, a sheet ejector 52, a conveyance route 53, and the like. In the three sheet feed tray units 51a to 51c constituting the sheet feeder 51, sheets S (standard sheets, special sheets) identified based on basis weight, size, and the like are housed for each type set in advance.

The conveyance route 53 includes a plurality of conveyance roller pairs such as a registration roller pair 53a, a normal conveyance route 53b along which the sheet S is passed through the image former 40 and the fixer 60 and is ejected to the outside of the image forming apparatus 1, and the like.

The sheets S housed in the sheet feed tray units 51a to 51c are fed out one by one starting from the uppermost sheet S and are conveyed to the image former 40 by the conveyance route 53. At the image former 40, the toner image on the intermediate transfer belt 421 is collectively secondary-transferred onto one surface of the sheet S, and a fixing process is performed at the fixer 60. The sheet S on which an image has been formed is ejected to the outside of the apparatus by the sheet ejector 52 including sheet ejection rollers 52a.

In addition, the conveyance route 53 includes a re-conveyance route 90 through which the sheet S is reversed and re-conveyed toward the image forming unit 41 (the fixer 60). The re-conveyance route 90 is provided, for example, below the normal conveyance route 53b, and includes a first route 91, a second route 92, and a third route 93.

The first route 91 is a route branching from the normal conveyance route 53b on the downstream side of the fixer 60, and extends, for example, downward from a branch point with the normal conveyance route 53b.

The second route 92 is a route for re-conveying the sheet S, which has been reversed, to the image forming unit 41, is connected to the first route 91 and the third route 93, and is connected to the upstream side of the image forming unit 41.

The third route 93 is a route for reversing the sheet S. The third route 93 is connected to the first route 91 and the second route 92, and extends in the horizontal direction. In the re-conveyance route 90, the sheet S that has been conveyed through the first route 91 is conveyed into the third route 93, whereby the sheet S is reversed. Then, when the sheet S is conveyed from the third route 93 into the second route 92, the sheet S which has been reversed is re-conveyed toward the image forming unit 41 (the fixer 60).

The third route 93 is provided with an abutting roller 94, a feeding roller 95, and a guide 200.

The abutting roller 94 is a roller for abutting on the leading end of the sheet S in order to correct an inclination of the sheet S conveyed to the third route 93. The abutting roller 94 is provided, in the third route 93, at a position on a side of a connection portion to the second route 92 in the horizontal direction.

The feeding roller 95 is a roller for feeding out the sheet S, which has been conveyed to the third route 93, to the second route 92 toward the fixer 60. The feeding roller 95 is provided, in the third route 93, at a position opposite to the connection portion to the second route 92 in the horizontal direction.

The guide 200 is a portion that guides the conveyance of the sheet S, and is provided in a range in which the abutting roller 94 and the feeding roller 95 are disposed. The guide 200 is disposed, in the third route 93, at a position facing the non-image-side surface (back surface) of the sheet S, for example, at a position of the upper wall of the third route 93.

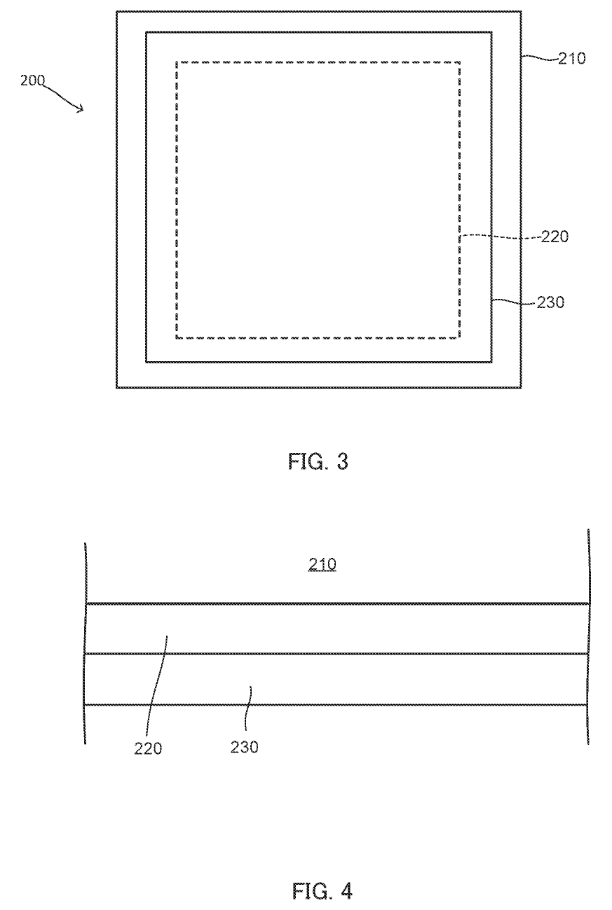

As illustrated in FIGS. 3 and 4, the guide 200 includes a guide plate 210, a heat insulating material 220, and a resin sheet 230.

The guide plate 210 is a guide member for conveying the sheet S, and is configured to have a width that makes it possible to guide the sheet S in its entirety (for example, a width wider than the width of the sheet S) in the width direction of the sheet S. The guide plate 210 is constituted by, for example, metal, and is grounded by being connected to a ground terminal (not illustrated) or the like.

The heat insulating material 220 serves for avoiding dew condensation that occurs due to a temperature difference in the space between the sheet S and the guide plate 210, and is, for example, a rectangular sheet member constituted by non-woven fabric or the like. The heat insulating material 220 is bonded to the guide plate 210 via, for example, an adhesive tape (not illustrated) or the like.

Since the sheet S immediately after passing through the fixing nip of the fixer 60 is in a high-temperature state due to the high temperature of the fixing nip, there is a possibility that dew condensation will occur due to a temperature difference in a space between the sheet S in a route and the route. In particular, for example, in a case where a period in which the sheet S is retained in a route occurs as in the third route 93 in the re-conveyance route 90, dew condensation is likely to occur.

In the present embodiment, the heat insulating material 220 is provided in the guide 200 of the third route 93, and thus, it is possible to suppress the occurrence of dew condensation.

The resin sheet 230 serves for suppressing the frictional resistance of the sheet S that is guided by the guide 200, and is a rectangular sheet member constituted by, for example, a synthetic resin having electrical conductivity (for example, polyethylene). The resin sheet 230 is provided on the front surface of the guide 200 such that the heat insulating material 220 is held between the resin sheet 230 and the guide plate 210, and is provided over the entire portion of the guide plate 210 in the width direction of the guide plate 210.

Note that, in a case where any other component (the feeding roller 95, a sensor, or the like) is provided at the guide plate 210, the resin sheet 230 may have a configuration in which a region corresponding to a portion of the other component is opened.

The resin sheet 230 is configured to be larger than the heat insulating material 220, and is disposed so as to cover the heat insulating material 220 in its entirety. In the resin sheet 230, a portion outside a range corresponding to the heat insulating material 220 (a portion protruding from the heat insulating material 220) is bonded to the guide plate 210 with a conductive adhesive. That is, the resin sheet 230 is disposed so as to be in contact with the guide plate 210. Since the guide plate 210 is grounded as described above, the resin sheet 230 is grounded.

Incidentally, when the resin sheet is disposed in a state of not being in contact with the guide plate, that is, in a state in which the resin sheet is not grounded, there is a possibility that the sheet will be electrostatically adsorbed to the resin sheet. When the sheet is electrostatically adsorbed to the resin sheet, the conveyance resistance may increase and defects such as jam and wrinkling of the sheet may occur.

In the present embodiment, the resin sheet 230 is grounded, and thus, it is possible to suppress the electrostatic adsorption of the sheet S to the resin sheet 230. As a result, the occurrence of the above-described defects can be suppressed.

That is, in the present embodiment, it is possible to suppress the occurrence of defects due to the electrostatic adsorption of the sheet S while suppressing the occurrence of dew condensation in the conveyance route 53.

In addition, since the resin sheet 230 can be grounded by the resin sheet 230 being bonded to the guide plate 210, the resin sheet 230 can be grounded by a simple method. As a result, the configuration of the guide 200 can be simplified.

In addition, since the resin sheet 230 is disposed so as to cover the heat insulating material 220, it is possible to secure a region in which the resin sheet 230 is bonded to the guide plate 210. As a result, it is possible to suppress the peeling-off of the resin sheet 230 from the guide plate 210 or a state in which the resin sheet 230 is floating from the guide plate 210, and further it is possible to achieve a sufficient grounding state. In addition, since it is configured such that the heat insulating material 220 and the sheet S do not come into contact with each other, it is possible to avoid contact between the heat insulating material 220 having a relatively large frictional resistance and the sheet S, and further it is possible to reduce the influence of the frictional resistance.

In addition, since the resin sheet 230 is provided over the entire portion of the guide plate 210 in the width direction of the guide plate 210, it is possible to suppress the electrostatic adsorption of the sheet S over the entire portion of the guide plate 210 in the width direction of the guide plate 210. For example, in a case where the resin sheet is configured to be provided in a portion of the guide plate in the width direction of the guide plate and when a sheet having a size larger than the resin sheet is conveyed, a portion of the sheet protruding from the resin sheet may be affected by electrostatic adsorption. In the present embodiment, the resin sheet 230 is provided over the entire portion of the guide plate 210 in the width direction of the guide plate 210, and thus, it is possible to suppress electrostatic adsorption no matter what size the sheet to be conveyed has.

In addition, since the re-conveyance route 90 is a route in which the sheet S that has passed through the fixing nip of the fixer 60 and is in a high-temperature state is retained, problems of dew condensation and electrostatic adsorption are likely to occur. In the present embodiment, the guide 200 is provided in the re-conveyance route 90 in which such problems are likely to occur, and thus, it is possible to effectively suppress the occurrence of the above-described problems.

In addition, the guide 200 is provided at the upper wall of the re-conveyance route 90 (the third route 93), and thus, the resin sheet 230 can be quickly warmed by warm water vapor rising from the sheet S. As a result, it is possible to make it difficult for dew condensation at the guide 200 to occur.

In addition, since the guide 200 is provided in the range in which the abutting roller 94 and the feeding roller 95 are disposed, the guide 200 is disposed in a situation in which the slack of the sheet S is likely to occur and the resin sheet 230 and the sheet S are like to come into contact with each other. That is, since the guide 200 is disposed at a position at which the electrostatic adsorption between the sheet S and the resin sheet 230 is likely to occur, it is possible to effectively suppress the occurrence of the electrostatic adsorption of the sheet S to the resin sheet 230.

Note that, although the resin sheet 230 is constituted by one sheet member corresponding to the guide plate 210 in its entirety in the embodiment described above, the present invention is not limited thereto. For example, the resin sheet 230 may be constituted by a plurality of sheet members.

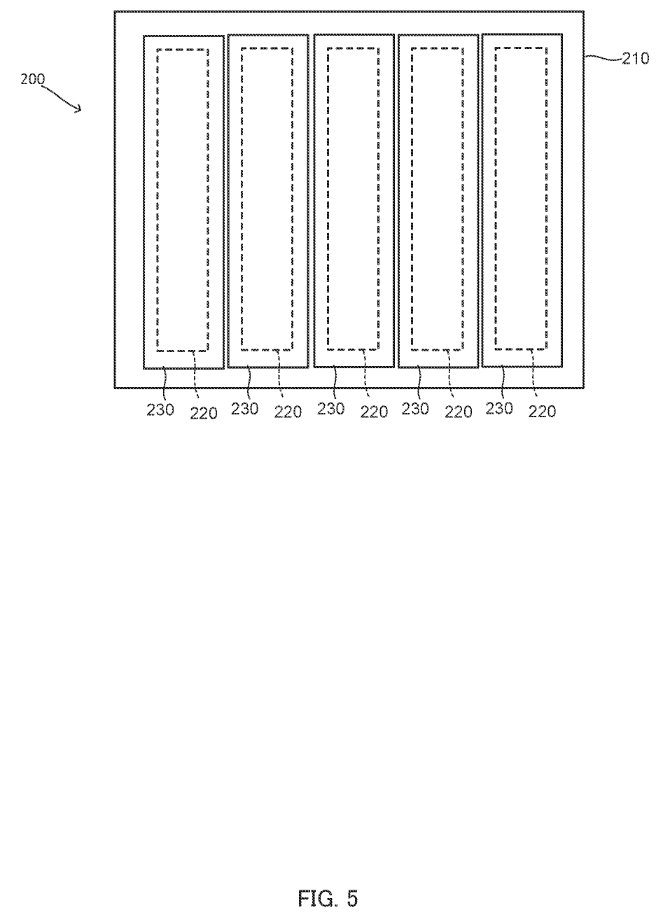

Specifically, as illustrated in FIG. 5, a plurality of the resin sheets 230 may be provided side by side in the width direction. Two resin sheets 230 adjacent to each other in the width direction are disposed with a gap between the two resin sheets 230. The length of the gap in the width direction can be arbitrarily set to, for example, a length, such as a 15 mm or less, which makes it possible to avoid direct contact of the sheet S with the guide plate 210 or the like by the sheet S entering the gap.

In this way, it is possible to form unevenness on the conveyance surface of the guide 200, and thus, it is possible to reduce the area in contact with the sheet S as a whole. As a result, the occurrence of the electrostatic adsorption of the sheet S to the resin sheet 230 can be further suppressed.

In addition, since the resin sheets 230 are disposed with a gap therebetween, the gap can be used as a channel for liquid based on water vapor generated from the sheet S in a high-temperature state. As a result, the influence of dew condensation at the guide 200 can be reduced.

In addition, in this configuration, a plurality of the heat insulating materials 220 may be provided according to the shape of the resin sheet 230. For example, each heat insulating material 220 may be formed in a size to be covered with each resin sheet 230.

In this way, it is possible to sufficiently secure the bonding area of each resin sheet 230. In addition, since the heat insulating material 220 is not exposed from the gap between the resin sheets 230, it is possible to suppress an increase in frictional resistance due to the heat insulating material 220.

In addition, in this configuration, each of the plurality of resin sheets 230 has substantially the same size, but the present invention is not limited thereto and each of the plurality of resin sheets may not have substantially the same size.

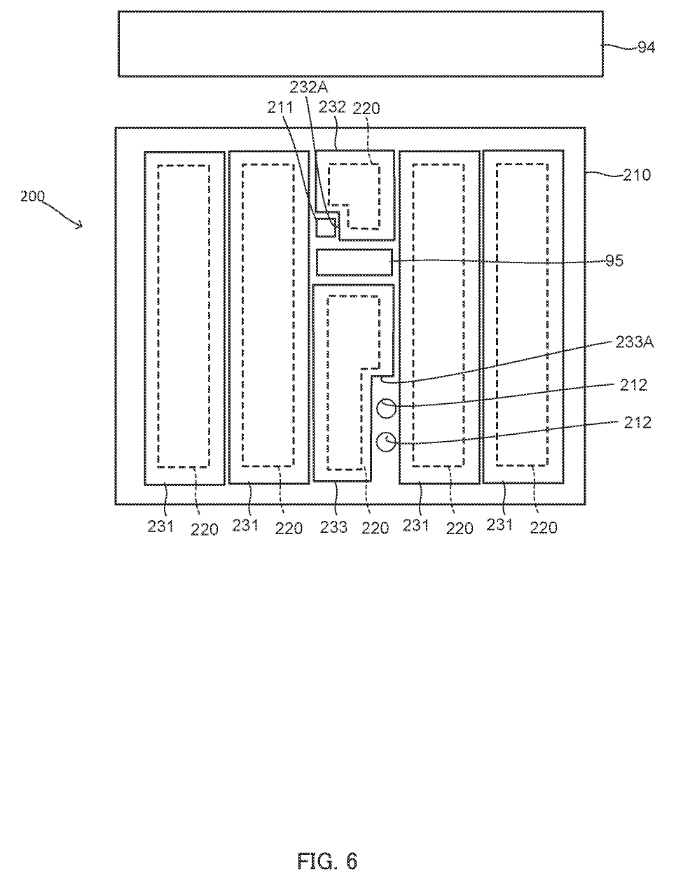

For instance, an example as illustrated in FIG. 6 is indicated in which a plurality of resin sheets 230 includes first sheets 231, a second sheet 232, and a third sheet 233 that have shapes different from each other. In addition, a sensor 211 for detecting the sheet S and the feeding roller 95 are provided at the guide plate 210 illustrated in FIG. 6.

The first sheet 231 is configured to have a rectangular shape, and two first sheets 231 are provided on each side of the second sheet 232 and the third sheet 233 in the width direction.

The second sheet 232 is provided, in a central portion of the guide plate 210 in the width direction of the guide plate 210, at the end on the side of the abutting roller 94. The sensor 211 is provided at a position corresponding to the second sheet 232 of the guide plate 210. A cutout 232A for the sensor 211 to be disposed therein is formed at a position corresponding to the sensor 211 of the second sheet 232.

The feeding roller 95 is provided at a position adjacent to the sensor 211 and the second sheet 232, and the third sheet 233 is provided at a position adjacent to the feeding roller 95.

The third sheet 233 is provided, in the central portion of the guide plate 210 in the width direction of the guide plate 210, on the side opposite to the second sheet 232 with the feeding roller 95 therebetween.

In addition, a hole 212 for light emitted by a sensor for detecting the sheet S to pass through is formed at a position corresponding to the third sheet 233 of the guide plate 210. A cutout 233A for avoiding overlapping with the hole 212 is formed at a position corresponding to the hole 212 of the third sheet 233.

In this way, when a plurality of resin sheets 230 includes a plurality of sheets having shapes different from each other, it is possible to configure sheet arrangement in consideration of the components of the guide plate 210, or the like.

In addition, in the above-described embodiment, the resin sheet 230 is disposed so as to cover the heat insulating material 220. However, the present invention is not limited thereto, and the resin sheet 230 may not cover the heat insulating material 220 as long as the bonding region of the resin sheet 230 can be secured.

In addition, although the resin sheet 230 is grounded by being bonded to the guide plate 210 in the embodiment described above, the present invention is not limited thereto. For example, the resin sheet 230 may be grounded by coming into contact with a ground terminal other than the guide plate 210.

In addition, although the sheet S is reversed by the re-conveyance route 90 including the third route 93 extending in the horizontal direction in the embodiment described above, the present invention is not limited thereto and the re-conveyance route 90 may have any shape as long as the sheet S can be reversed.

In addition, although the guide 200 is provided in the re-conveyance route 90 in the above-described embodiment, the present invention is not limited thereto, and a guide may not be provided in the re-conveyance route as long as the re-conveyance route is a route in which the sheet S after fixation is caused to be retained. Examples of the route in which the sheet after fixation is caused to be retained include a conveyance route in a reading apparatus provided on the downstream side of the fixer 60 and a conveyance route on the upstream side of a post-processing apparatus. In the conveyance route in the reading apparatus, for example, a sheet is retained in the route while the sheet waits for reading by a reader. In addition, in the conveyance route on the upstream side of the post-processing apparatus, for example, a sheet is retained in the route while the sheet is on standby to be conveyed into the post-processing apparatus.

In addition, although the image forming apparatus 1 has been exemplified as the conveyance apparatus in the above-described embodiment, the present invention is not limited thereto. The conveyance apparatus may be, for example, an apparatus (such as a reading apparatus or a post-processing apparatus) including a conveyance route into which the sheet S that has passed through the fixer 60 in the image forming apparatus 1 is conveyed.

In addition, any of the embodiment described above is only illustration of an exemplary embodiment for carrying out the present invention, and the technical scope of the present invention shall not be construed limitedly thereby. That is, the present invention can be carried out in various forms without departing from the gist or the main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A conveyance apparatus, comprising:
a conveyance route that conveys a recording medium on which an image has been fixed by a fixer;
a guide plate that is provided in the conveyance route and guides conveyance of the recording medium;
a heat insulating material that is attached to the guide plate; and
a resin sheet having electrical conductivity that is provided such that the heat insulating material is held between the resin sheet and the guide plate, wherein
the resin sheet is grounded.

2. The conveyance apparatus according to claim 1, wherein
the resin sheet is bonded to the guide plate.

3. The conveyance apparatus according to claim 2, wherein
the guide plate is constituted by metal.

4. The conveyance apparatus according to claim 1, wherein
the resin sheet is disposed so as to cover the heat insulating material.

5. The conveyance apparatus according to claim 1, wherein
the resin sheet is provided over an entire portion of the guide plate in a width direction of the guide plate.

6. The conveyance apparatus according to claim 5, wherein:
a plurality of the resin sheets is provided side by side in the width direction, and
two resin sheets of the plurality of resin sheets are disposed with a gap between the two resin sheets, the two resin sheets being adjacent to each other in the width direction.

7. The conveyance apparatus according to claim 1, wherein
the conveyance route is a re-conveyance route through which the recording medium is reversed and re-conveyed toward the fixer.

8. The conveyance apparatus according to claim 7, wherein
the guide plate is disposed, in the conveyance route, at a position facing a non-image-side surface of the recording medium, the position being a position of an upper wall of the conveyance route.

9. The conveyance apparatus according to claim 7, further comprising:
an abutting roller that is disposed in the conveyance route and abuts on a leading end of the recording medium; and
a feeding roller that is disposed in the conveyance route and feeds out the recording medium toward the fixer, wherein
the resin sheet is provided in a range in which the abutting roller and the feeding roller are disposed.

10. The conveyance apparatus according to claim 1, further comprising:
an image former that forms an image on a recording medium; and
a fixer that fixes the image formed by the image former on the recording medium.
